(19) United States
(12) Patent Application Publication
(10) Pub. No.: US 2008/0010673 A1
(43) Pub. Date: Jan. 10, 2008

(54) System, apparatus, and method for user authentication

(75) Inventors: Tomokazu Makino, Fukuoka (JP); Harutaka Tanaka, Fukuoka (JP); Satoshi Hamanaka, Fukuoka (JP); Yukimasa Takahira, Fukuoka (JP); Daiji Itou, Fukuoka (JP); Masaaki Ishibashi, Fukuoka (JP); Katsuyuki Fujiyoshi, Fukuoka (JP); Takashi Ishii, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/706,984

(22) Filed: Feb. 16, 2007

(30) Foreign Application Priority Data
Jul. 7, 2006 (JP) 2006-187908

(51) Int. Cl. H04L 9/32

(52) U.S. Cl. 726/6

(57) ABSTRACT

An authentication system performs user authentication between a client and a server using a one-time password. Each of the client and the server generates random authentication data. The generated random authentication data is exchanged between the client and the server. In this way, authentication based on a complete random authentication data not using specific one-time password generation logic can be provided. Furthermore, by applying the method for authentication and the method for updating a one-time password according to the present invention, spoofing can be detected even when a password is stolen. As a result, unauthorized access can be prevented.

### BACKGROUND OF THE INVENTION

1. Field of the Invention

The present invention relates to a method and a system for performing personal authentication using authentication data (one-time password) generated each time a user operates his computer in order to access a different computer providing a service.

2. Description of the Related Art

Japanese Unexamined Patent Application Publication No. 8-227397 (U.S. Pat. No. 5,604,803 is its priority application) describes a remote authentication method, which is a related technology of this invention. According to this known remote authentication method, an Internet user uses a one-time password that can be used only once, thereby preventing unauthorized users (such as hackers) from logging in.

Additionally, Japanese Unexamined Patent Application Publication No. 11-289328 describes an authentication management apparatus, which is a related technology of this invention. This known authentication management apparatus can protect against unauthorized access from a modem connection point and can detect an authorized terminal.

However, in the above-described known authentication method, if a third party (such as a cracker) has acquired a password that the user of a first computer (a client) inputs and decryption logic, the third party can gain unauthorized access from a computer of the third party by spoofing the information.

Additionally, even in the above-described known authentication management apparatus, if a third party has acquired a password input by a user and the transmission history of a token transmitted from an authentication server at random times, the third party can gain unauthorized access by spoofing the information. Furthermore, since a key that has been determined on the basis of a predetermined rule (such as a time) is used, it is easy for a third party to estimate and spoof the key if the third party has acquired the decryption logic.

### SUMMARY OF THE INVENTION

Accordingly, it is an object of the present invention to provide a system and a method for authentication for comprehensively preventing unauthorized access by spoofing. It is another object of the present invention to provide a system and a method for authentication for preventing unauthorized access even when a third party (such as a cracker) acquires information about the authentication.

An authentication system according to an aspect of the present invention includes a first apparatus and a second apparatus connected each other via a network.

The first apparatus includes an input means which inputs a user password used for user authentication, a first receiving means which receives second random authentication data from the second apparatus, a first authentication data generating means which generates first random authentication data, a first storage which stores a random one-time password including the second random authentication data received from the second apparatus and the first random authentication data, and a first transmitting means which transmits the user password and the random one-time password to the second apparatus and which transmits a user authentication request including the user password and the random one-time password to the second apparatus.

The second apparatus includes a second receiving means which receives the user password and the random one-time password from the first apparatus and which receives the user authentication request from the first apparatus, a second authentication data generating means which generates the second random authentication data, a second storage which stores the user password and which stores the random one-time password received from the first apparatus with the user password, a second transmitting means which transmits the second random authentication data to the first apparatus, and a second authenticating means which authenticates a sender of the user authentication request by matching the user password and the random one-time password included in the user authentication request with the user password and the random one-time password stored in the second storage respectively.

In the authentication system, the first storage may store first specific data for identifying the first apparatus, the first transmitting means may transmit the user password and the first specific data to the second apparatus, and the first transmitting means may transmit an automatic update request including the first specific data and the random one-time password to the second apparatus at a first predetermined interval.

The second receiving means may receive the user password and the first specific data from the first apparatus, the second storage may store the first specific data with the user password, the second receiving means may receive the automatic update request from the first apparatus, and the second authenticating means may authenticate a sender of the automatic update request by matching the first specific data and the random one-time password included in the automatic update request with the first specific data and the random one-time password stored in the second storage respectively.

In the authentication system, the first transmitting means may stop transmitting the automatic update request before transmitting the user authentication request and may resume transmitting the automatic update request after the completion of the user authentication, and the second authenticating means may wait for a third predetermined interval which is longer than the first predetermined interval, before starting the user authentication.

The foregoing summary is not intended to be inclusive of all the features of the present invention. Therefore, it is apparent that any combination of the features described in this specification is also included within the scope of the present invention.

According to the present invention, random authentication data is generated by each of a client and a server and is stored in both the client and the server. Thus, authentication using a random one-time password that does not depend on specific one-time password generation logic can be provided.

Furthermore, by applying the method for authentication and the method for updating a one-time password according to the present invention, spoofing can be detected even when a password is stolen. As a result, unauthorized access can be prevented.

### BRIEF DESCRIPTION OF THE DRAWINGS

FIG. 1 is an exemplary system configuration according to the present invention;

FIG. 2 is a diagram illustrating the principle of the present invention;

FIG. 3 is a sequence diagram of an authentication system according to a first exemplary embodiment of the present invention;

FIG. 4 is a sequence diagram of an authentication system according to the first exemplary embodiment of the present invention;

FIG. 5 is a sequence diagram of an authentication system according to a second exemplary embodiment of the present invention;

FIG. 6 is a sequence diagram illustrating the operation of a computer 1 according to a fourth exemplary embodiment of the present invention;

FIG. 7 is a sequence diagram illustrating the user authentication operation of a computer 2 according to the fourth exemplary embodiment of the present invention;

FIG. 8 is a sequence diagram of an authentication system according to a fifth exemplary embodiment of the present invention;

FIG. 9 is a diagram illustrating Example 3;

FIG. 10 is a diagram illustrating Example 4;

FIG. 11 illustrates exemplary information registered in a database of a server in examples; and

FIG. 12 illustrates exemplary information stored in a storage area of a mobile device in examples.

### DESCRIPTION OF THE PREFERRED EMBODIMENTS

### First Exemplary Embodiment

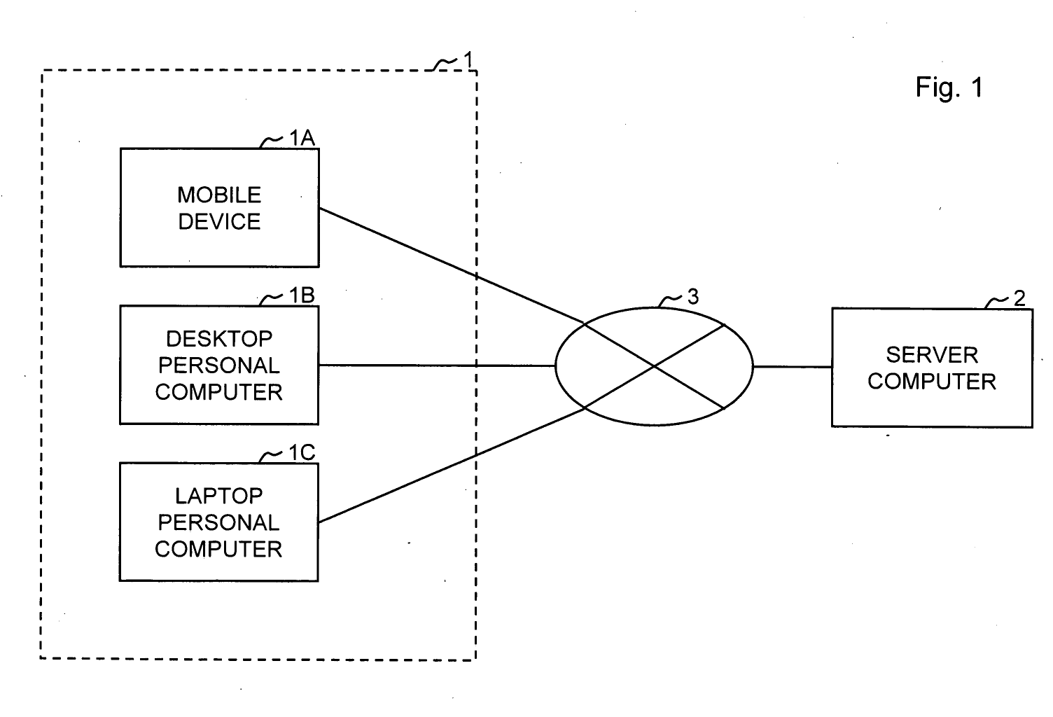

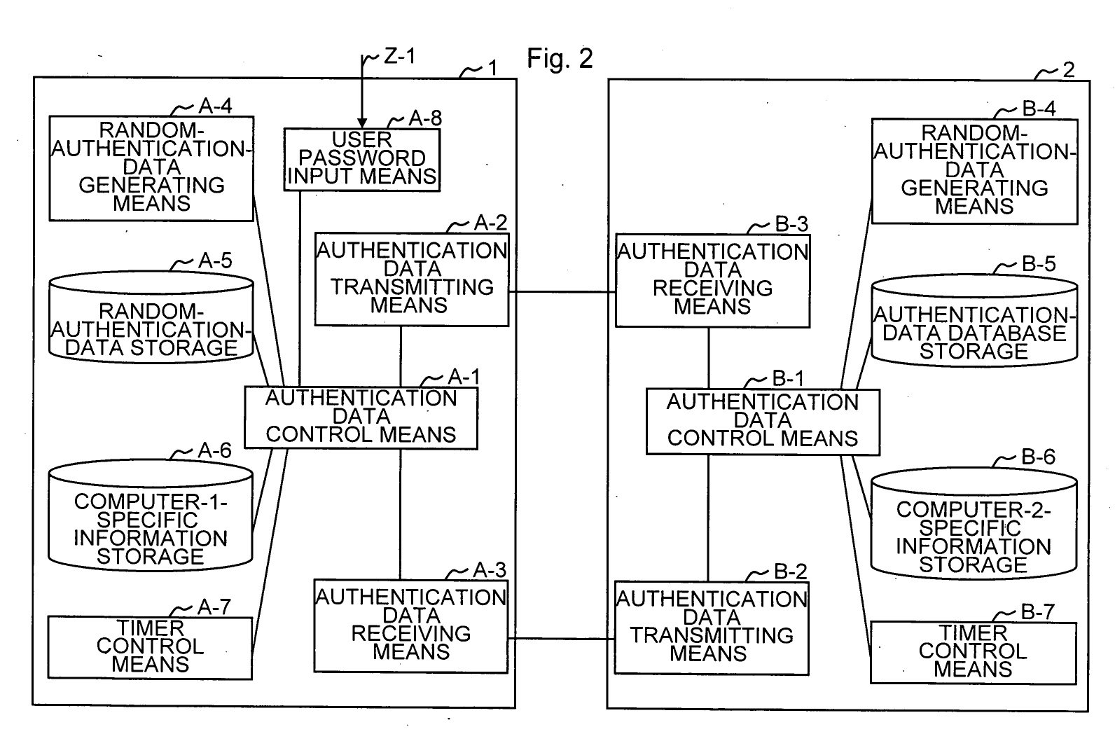

FIG. 1 is a diagram illustrating an exemplary system configuration according to the present invention. FIG. 2 is a diagram illustrating the principle of the present invention. A user may access a server computer 2 via different computers 1, for example, a computer 1A (a mobile device), a computer 1B (a desktop personal computer), and a computer 1C (a laptop personal computer) using the same user ID (information for identifying the user).

### 1-1. System Configuration

According to a first exemplary embodiment of the present invention, an authentication system includes at least one computer 1. The authentication system further includes a computer 2 to which the computer 1 is connected via communicating means, such as a communication network.

The computer 1 includes a user password input means A-8 for inputting a user password when a user makes user registration and the user requests an access to the computer 2, a random-authentication-data generating means A-4 for generating random authentication data when the computer 1 sends a user authentication request to the computer 2 or every time the computer 1 sends an automatic update request of a random one-time password to the computer 2 at a predetermined interval, a random-authentication-data storage A-5 for storing random one-time passwords including the random authentication data generated by the computer 1 and the computer 2, computer-1-specific information storage A-6 for storing computer-1-specific information for identifying each of computers 1 connected to the computer 2, an authentication data transmitting means A-2 for transmitting the user password and the random one-time password to the computer 2, an authentication data receiving means A-3 for receiving from the computer 2 the result of user authentication and authentication data generated by the computer 2, and an authentication data control means A-1 for controlling the generation, management, and transmission/reception of authentication data generated by the computer 1 and the computer 2. Note that a timer control means A-7 shown in FIG. 2 is not used in the present exemplary embodiment. The timer control means A-7 is used in a second exemplary embodiment.

The computer 2 includes a random-authentication-data generating means B-4 for generating random data when the computer 2 receives a user authentication request from the computer 1 or every time the computer 2 receives an automatic update request of a random one-time password from the computer 1 at a predetermined interval, an authentication data database storage B-5 for storing authentication data database including random authentication data generated by the computer 1 and the computer 2 and the result of the user authentication requested by the computer 1, an authentication data transmitting means B-2 for transmitting the random authentication data generated by the computer 2, the user authentication result, or the result of automatic update of the random one-time password to the computer 1, an authentication data receiving means B-3 for receiving the user password and the random one-time password from the computer 1, and an authentication data control means B-1 for controlling the generation, management, and transmission/reception of the authentication data generated by the computer 1 and the computer 2. Note that computer-2-specific information storage B-6 and a timer control means B-7 shown in FIG. 2 are not used in the present exemplary embodiment. The computer-2-specific information storage B-6 is used in a sixth exemplary embodiment. The timer control means B-7 is used in a fourth exemplary embodiment.

The authentication system includes the computer 1 and the computer 2 and performs user authentication using random authentication data.

The computer 1 includes a central processing unit (CPU), a main memory such as a dynamic random access memory (DRAM), a hard disk (HD) serving as an external storage unit, a keyboard and a mouse serving as an input unit, a local area network (LAN) card serving as an add-on expansion board for connecting the computer 1 to a network, and a compact disc-read only memory (CD-ROM) drive. The computer 2 has a similar hardware configuration.

### 1-2. Operations

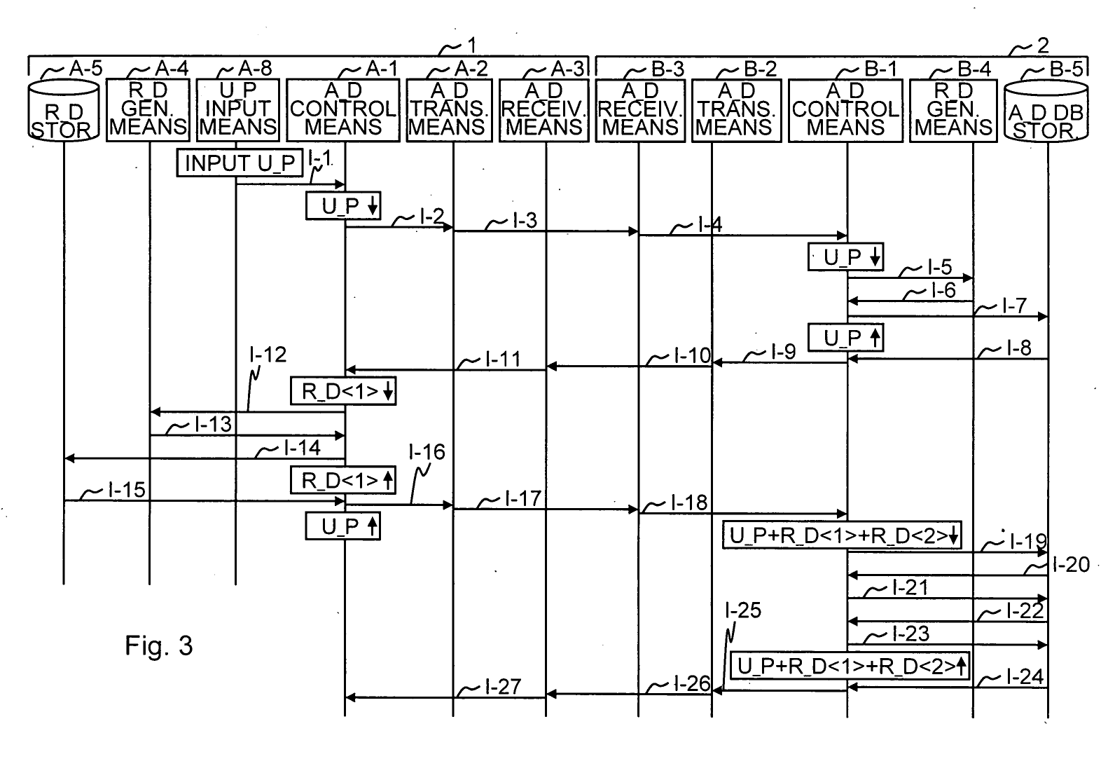

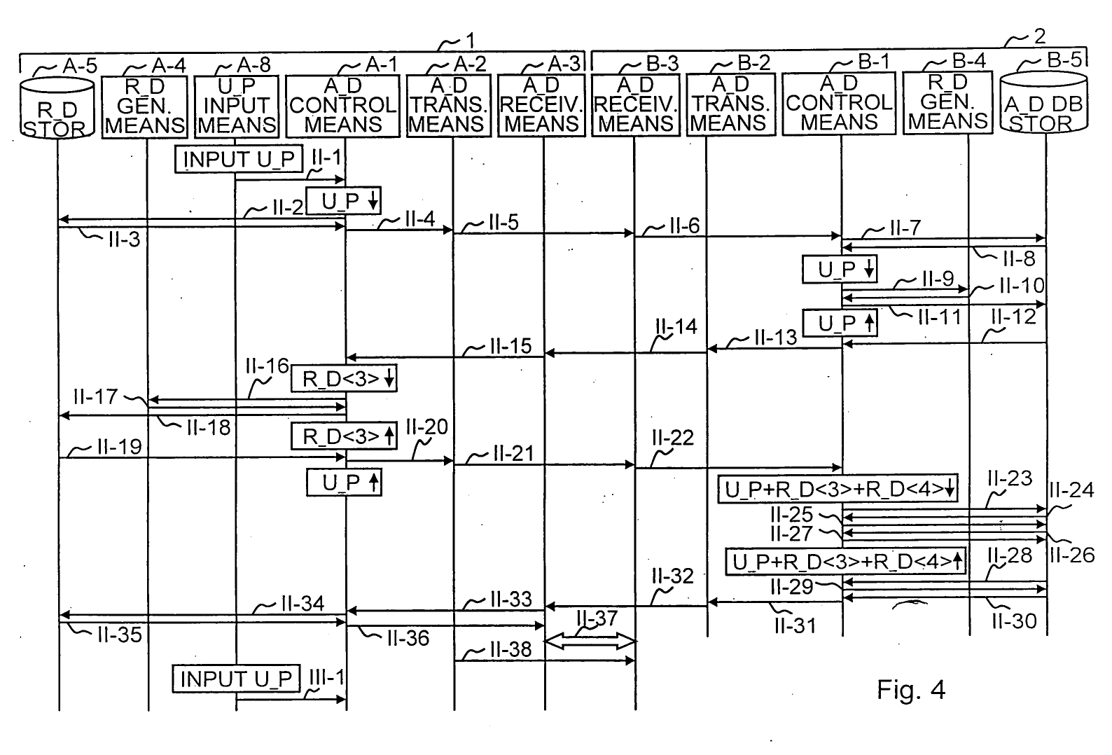

FIGS. 3 and 4 are sequence diagrams of the authentication system according to the present exemplary embodiment. In FIGS. 3 and 4, U_P stands for user password, R_D stands for random authentication data, a downward arrow means “set in temporal memory”, and an upward arrow means “delete from temporal memory”.

### 1-2.1 User Registration Phase

First, a procedure is described in which a user registers a user password in the computer 2 in order to access the computer 2.

The user ID is stored in the random-authentication-data storage A-5 in advance. In the description hereinafter, when the computer 1 transmits any data to the computer 2, the computer 1 also transmits the user ID unless otherwise described. The user ID is also registered in the authentication data database stored in the authentication data database storage B-5 in advance. The authentication is performed for the user ID.

The user who desires to access the computer 2 inputs a user password for accessing the computer 2 via the user password input means A-8 of the computer 1 (I-1). The authentication data control means A-1 transmits the user password to the computer 2 via the authentication data transmitting means A-2 (I-2 and I-3).

The computer 2 receives the user password transmitted from the computer 1 via the authentication data receiving means B-3 (I-3). Thereafter, the computer 2 delivers the user password to the authentication data control means B-1 (I-4).

The authentication data control means B-1 of the computer 2 generates a random authentication data <1> using the random-authentication-data generating means B-4 (I-5 and I-6). Subsequently, the authentication data control means B-1 registers data composed of the user password and the generated random authentication data <1> in the authentication data database (I-7).

After the information is registered (I-8), the authentication data control means B-1 transmits the random authentication data <1> to the computer 1 via the authentication data transmitting means B-2 (I-9 and I-10).

The computer 1 receives the random authentication data <1> transmitted from the computer 2 via the authentication data receiving means A-3 (I-10) and delivers the random authentication data <1> to the authentication data control means A-1 (I-11).

Upon receiving the random authentication data <1> generated by the computer 2, the authentication data control means A-1 of the computer 1 generates a new random authentication data <2> using the random-authentication-data generating means A-4 (I-12 and I-13). Thereafter, the authentication data control means A-1 stores the random authentication data <1> and the random authentication data <2> in the random-authentication-data storage A-5 (I-14). If the random authentication data <1> and the random authentication data <2> are successfully stored, the authentication data control means A-1 transmits authentication data composed of the user password, the random authentication data <1>, and the random authentication data <2> to the computer 2 via the authentication data transmitting means A-2 (I-15 through I-17). Hereafter, data composed of the random authentication data <1> and the random authentication data <2> may be referred to as a random one-time password.

The computer 2 receives the authentication data transmitted from the computer 1 via the authentication data receiving means B-3 (I-17) and delivers the authentication data to the authentication data control means B-1 (I-18).

The authentication data control means B-1 of the computer 2 determines whether data composed of the user password and the random authentication data <1> included in the authentication data is present in the authentication data database stored in the authentication data database storage B-5 (I-19). If the data is present (I-20), the authentication data control means B-1 deletes the data composed of the user password and the random authentication data <1> included in the authentication data from the authentication data database stored in the authentication data database storage B-5 (I-21 and I-22).

Subsequently, the authentication data control means B-1 registers data composed of the user password, the random authentication data <I>, and the random authentication data <2> included in the authentication data in the authentication data database stored in the authentication data database storage B-5 (I-23 and I-24).

If the data is successfully registered, the authentication data control means B-1 transmits a registration completion message of the random one-time password to the computer 1 via the authentication data transmitting means B-2 (I-25 through I-27).

Thus, the user registration in the computer 2 has been completed. The random authentication data <1> and the random authentication data <2> are stored in the computer 1 and the computer 2.

### 1-2.2 Operation Phase

A procedure for performing user authentication is described next when the user of the computer 1 accesses the computer 2.

A user who desires to use the computer 2 inputs a user password for accessing the computer 2 via the user password input means A-8 of the computer 1 (II-1). The authentication data control means A-1 acquires the random authentication data <1> and the random authentication data <2> stored in the random-authentication-data storage A-5 (II-2 and II-3). The authentication data control means A-1 then transmits authentication data composed of the user password that the user has input via the user password input means A-8, the acquired random authentication data <I>, and the acquired random authentication data <2>, via the authentication data transmitting means A-2 (II-4 and II-5).

The computer 2 receives the authentication data transmitted from the computer 1 via the authentication data receiving means B-3 (II-5) and delivers the authentication data to the authentication data control means B-1 (II-6).

The authentication data control means B-1 of the computer 2 determines whether data composed of the user password, the random authentication data <1>, and the random authentication data <2> included in the authentication data is present in the authentication data database stored in the authentication data database storage B-5 (II-7). If the data is present (II-8), the authentication data control means B-1 generates a new random authentication data <3> using the random-authentication-data generating means B-4 (II-9 and II-10). Thereafter, the authentication data control means B-1 registers data composed of the user password included in the authentication data and the generated random authentication data <3> in the authentication data database stored in the authentication data database storage B-5 (II-11).

After the data is registered (II-12), the authentication data control means B-1 transmits the random authentication data <3> to the computer 1 via the authentication data transmitting means B-2 (II-13 and II-14).

The computer 1 receives the random authentication data <3> transmitted from the computer 2 via the authentication data receiving means A-3 (II-14) and delivers the random authentication data <3> to the authentication data control means A-1 (II-15).

Upon receiving the random authentication data <3> generated by the computer 2, the authentication data control means A-1 generates new random authentication data <4> using the random-authentication-data generating means A-4 (II-16 and II-17). Thereafter, the authentication data control means A-1 stores data composed of the random authentication data <3> and the random authentication data <4> in the random-authentication-data storage A-5 (II-18).

If the data is successfully stored (II-19), the authentication data control means A-1 transmits authentication data composed of the user password, the random authentication data <3>, and the random authentication data <4>, to the computer 2 via the authentication data transmitting means A-2 (II-20 and II-21). Hereafter, data composed of the random authentication data <3> and the random authentication data <4> may be referred to as a random one-time password.

The computer 2 receives the authentication data transmitted from the computer 1 via the authentication data receiving means B-3 (II-21) and delivers the authentication data to the authentication data control means B-1 (II-22).

The authentication data control means B-1 of the computer 2 determines whether data composed of the user password and the random authentication data <3> included in the authentication data is present in the authentication data database stored in the authentication data database storage B-5 (II-23). If the data is present (II-24), the authentication data control means B-1 deletes the data composed of the user password and the random authentication data <3> included in the authentication data, from the authentication data database stored in the authentication data database storage B-5 (II-25 and II-26). Thereafter, the authentication data control means B-1 registers data composed of the user password, the random authentication data <3>, and the random authentication data <4> included in the authentication data, in the authentication data database stored in the authentication data database storage B-5 (II-27).

If the data is successfully registered (II-28), the authentication data control means B-1 deletes the data composed of the user password, the random authentication data <1>, and the random authentication data <2> from the authentication data database stored in the authentication data database storage B-5 (II-29 and II-30).

After the data has been deleted, the authentication data control means B-1 transmits an access permission message to the computer 1 via the authentication data transmitting means B-2 (II-31 and II-32).

Upon receiving the access permission message transmitted from the computer 2 via the authentication data receiving means A-3 (II-33), the authentication data control means A-1 of the computer 1 deletes the random authentication data <1> and the random authentication data <2> from the random-authentication-data storage A-5. Thus, the processing is completed (II-34 and II-35).

By executing the above-described operation phase, user authentication can be performed using authentication data that changes every time user authentication is performed, that is, the authentication system requires different authentication data each time the user access the computer 2.

The operation phase is repeatedly executed from the notation “(INPUT U_P) III-1” shown in FIG. 4.

The random authentication data generated by the computer 1 and the random authentication data generated by the computer 2 are combined to generate a random one-time password which is random authentication data updated each time user authentication is performed. The generated random one-time password is stored in the storage means of the computer 1 and the storage means of the computer 2. Thus, a secure user authentication is performed using the stored random one-time password together with the user password.

According to the present invention, the authentication data generated by the computer 1 and the authentication data generated by the computer 2 are stored in the computer 1 and the computer 2. User authentication is performed using the stored authentication data and the user password. Accordingly, even when a third party attempts spoofing, it is extremely difficult for the third party to gain unauthorized access to the computer 2 since both computers generate the authentication data. In particular, the present invention is more advantageous since the two authentication data are random authentication data without regularity.

Examples of the storage means include a cache, a memory, and a hard disk.

The random one-time password can be generated from first authentication data and second authentication data while scrambling those data. The data-scrambling encryption technique is common in a cryptographic theory.

The term “computer 1” is also referred to as a first computer and the term “computer 2” is also referred to as a second computer or a server computer.

### Second Exemplary Embodiment

The authentication system can use computer-1-specific information in place of the user password and automatically update the random one-time password between the computer 1 and the computer 2 at any interval.

As used herein, the term “any interval” refers to a predetermined fixed interval, an interval set by a user, or a variable interval.

### 2-1. System Configuration

According to a second exemplary embodiment of the present invention, an authentication system has a configuration similar to that of the authentication system according to the first exemplary embodiment. A computer 1 includes a timer control means A-7 for starting the periodical automatic update operation of a random one-time password. Unlike the authentication system according to the first exemplary embodiment, the authentication system according to the present exemplary embodiment periodically updates random one-time password stored in the computer 1 and the computer 2.

### 2-2. Operations

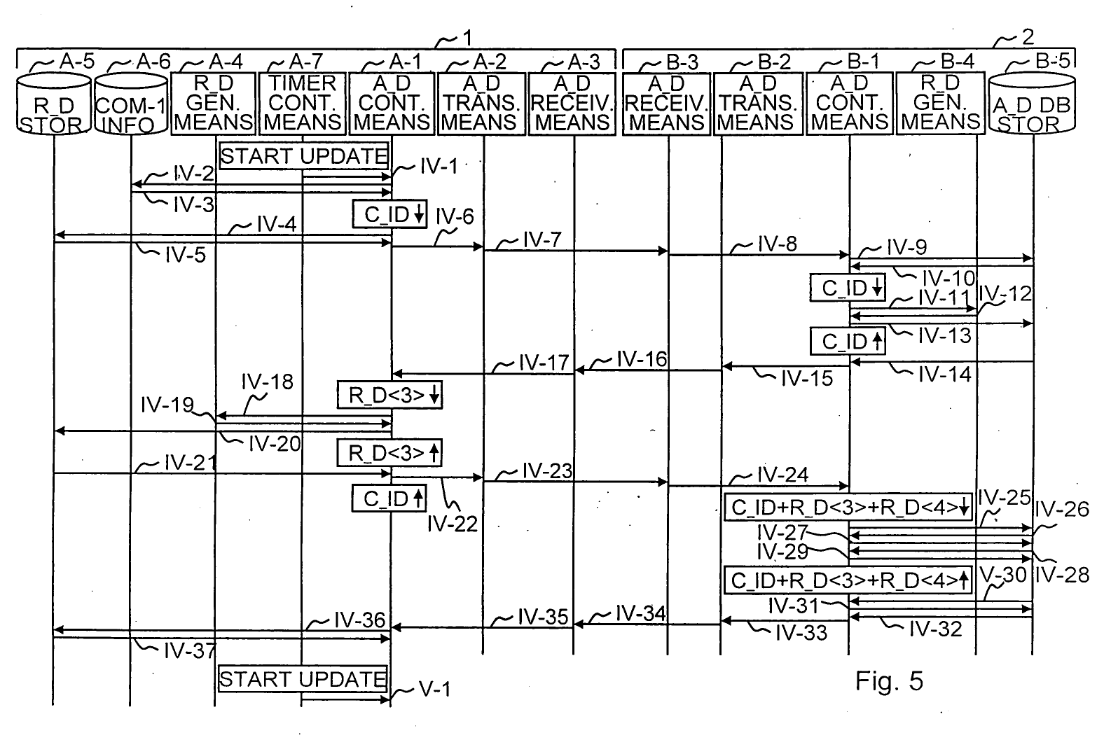

FIG. 5 is a sequence diagram of the authentication system according to the present exemplary embodiment. In FIG. 5, C_ID stands for computer-1-specific information, R_D stands for random authentication data, a downward arrow means “set in temporal memory”, and an upward arrow means “delete from temporal memory”.

The timer control means A-7 of the computer 1 sends an update request of the random authentication data to the authentication data control means A-1 at a predetermined activation interval (IV-1).

The random-authentication-data storage A-5 stores the user ID, random authentication data <1> generated by the computer 2, and random authentication data <2> generated by the computer 1 in advance.

The authentication data database storage B-5 stores the authentication data database including the user ID, the user password, the computer-1-specific information, random authentication data <1>, and random authentication data <2> in advance.

The authentication data control means A-1 acquires random authentication data <1> and random authentication data <2> from the random-authentication-data storage A-5 (IV-2 through IV-5). Subsequently, the authentication data control means A-1 transmits authentication data composed of computer-1-specific information, the random authentication data <1>, and the random authentication data <2>, to the computer 2 via the authentication data transmitting means A-2 (IV-6 and IV-7).

The computer 2 receives the authentication data transmitted from the computer 1 via the authentication data receiving means B-3 (IV-7) and delivers the authentication data to the authentication data control means B-1 (IV-8).

The authentication data control means B-1 of the computer 2 determines whether data composed of the computer-1-specific information, the random authentication data <1>, and the random authentication data <2> included in the authentication data is present in the authentication data database stored in the authentication data database storage B-5 (IV-9). If the data is present (IV-10), the authentication data control means B-1 generates new random authentication data <3> using the random-authentication-data generating means B-4 (IV-11 and IV-12). Thereafter, the authentication data control means B-1 registers data composed of the computer-1-specific information included in the authentication data and the generated random authentication data <3> in the authentication data database stored in the authentication data database storage B-5 (IV-13).

After the data is registered (IV-14), the authentication data control means B-1 transmits the random authentication data <3> to the computer 1 via the authentication data transmitting means B-2 (IV-15 and IV-16).

The computer 1 receives the random authentication data <3> transmitted from the computer 2 via the authentication data receiving means A-3 (IV-16) and delivers the random authentication data <3> to the authentication data control means A-1 (IV-17).

Upon receiving the random authentication data <3> generated by the computer 2 (IV-17), the authentication data control means A-1 of the computer 1 generates new random authentication data <4> using the random-authentication-data generating means A-4 (IV-18 and IV-19). Subsequently, the authentication data control means A-1 stores data composed of the random authentication data <3> and the random authentication data <4> in the random-authentication-data storage A-5 (IV-20).

If the data is successfully stored (IV-21), the authentication data control means A-1 transmits authentication data composed of the computer-1-specific information, the random authentication data <3>, and the random authentication data <4>, to the computer 2 via the authentication data transmitting means A-2 (IV-22 and IV-23).

Subsequently, the computer 2 receives the authentication data transmitted from the computer 1 via the authentication data receiving means B-3 (IV-23) and delivers the authentication data to the authentication data control means B-1 (IV-24).

The authentication data control means B-1 of the computer 2 determines whether data composed of the computer-1-specific information and the random authentication data <3> included in the authentication data is present in the authentication data database stored in the authentication data database storage B-5 (IV-25). If the data is present (IV-26), the authentication data control means B-1 deletes the data composed of the computer-1-specific information and the random authentication data <3> included in the authentication data, from the authentication data database stored in the authentication data database storage B-5 (IV-27 and IV-28). The authentication data control means B-1 then registers data composed of the computer-1-specific information, the random authentication data <3>, and the random authentication data <4> included in the authentication data in the authentication data database stored in the authentication data database storage B-5 (IV-29).

If the data is successfully registered (IV-30), the authentication data control means B-1 deletes the data composed of the computer-1-specific information, the random authentication data <I>, and the random authentication data <2>, from the authentication data database stored in the authentication data database storage B-5 (IV-31 and IV-32).

After the deletion of the data is completed, the authentication data control means B-1 transmits a registration completion message of a random one-time password to the computer 1 via the authentication data transmitting means B-2 (IV-33 and IV-34).

Subsequently, the authentication data control means A-1 of the computer 1 receives the registration completion message of a random one-time password transmitted from the computer 2 via the authentication data receiving means A-3 (IV-35). Thereafter, the authentication data control means A-1 deletes the data composed of the random authentication data <1> and the random authentication data <2> from the random-authentication-data storage A-5 (IV-36 and IV-37). Thus, the processing is completed.

Through the above-described operations, the random one-time password is automatically updated. The random one-time password is automatically updated at a predetermined activation interval.

Accordingly, since the authentication system uses computer-1-specific information and does not use a user password, a user need not input a password. Additionally, the random one-time password is automatically updated. Accordingly, even when a third party other than an authorized user acquires the generated random one-time password, the random one-time password is effective only in the automatic update interval. As a result, unauthorized access by spoofing can be prevented.

### Third Exemplary Embodiment

According to a third exemplary embodiment of the present invention, an authentication system has a configuration similar to that of the authentication system according to the first exemplary embodiment. Unlike the authentication system according to the first exemplary embodiment, the authentication data control means B-1 of the computer 2 determines whether the user authentication request from the computer 1 is valid on the basis of information included in the user authentication request and information included in the authentication data database stored in the authentication data database storage B-5. If an unauthorized request is made, the authentication data control means B-1 can detect the unauthorized request.

Upon receiving authentication data from the computer 1 during the phases described in “1-2.2 Operation phase” of the first exemplary embodiment or “2-2. Operations” of the second exemplary embodiment, the authentication data control means B-1 of the computer 2 determines whether data composed of the user password (or the computer-1-specific information), random authentication data <1>, and random authentication data <2> included in the authentication data is present in the authentication data database stored in the authentication data database storage B-5. If the data is not present, that is, if the result of step I-19 shown in FIG. 3 or the result of step IV-9 shown in FIG. 5 is unsuccessful, the authentication data control means B-1 transmits the result of the user authentication or the result of automatic update of the random one-time password to the computer 1 via the authentication data transmitting means B-2 without carrying out the update process of the random one-time password.

At that time, if the random authentication data <1> or the random authentication data <2> is not correct although the user password or the computer-1-specific information is correct or if the computer-1-specific information is not correct although the random authentication data <1> and the random authentication data <2> are correct, the authentication data control means B-1 can determine that the access is coming from a third party that is not an authorized user. If the user password is not correct although the random authentication data <1> and the random authentication data <2> are correct, the authentication data control means B-1 can determine that the user has failed to input his password.

Furthermore, if the matching result in step II-23 shown in FIG. 4 or the matching result in step IV-25 shown in FIG. 5 is that of an unsuccessful match, the authentication data control means B-1 of the computer 2 sets the information registered in the authentication data database stored in the authentication data database storage B-5 back to the information at the time when the user authentication started in the first exemplary embodiment or the information at the time when the automatic update started in the second exemplary embodiment.

Since the computer 2 compares the user password (or the computer-1-specific information) and the random one-time password received from the computer 1 with the user password (or the computer-1-specific information) and the random one-time password stored in the computer 2, respectively, unauthorized access from a third party other than an authorized user can be detected.

As a result of the comparison, if one of these data items is not correct, the authentication system can output the information about the unauthorized access by a third party to the computer 2 and/or the computer 1. Additionally, the authentication system can output the information to a computer used by a system administrator, different from the computer 2 and the computer 1.

### Fourth Exemplary Embodiment

According to a fourth exemplary embodiment of the present invention, an authentication system may have a configuration similar to any one of those authentication systems according to the first to third exemplary embodiments. A computer 2 includes a timer control means B-7 for managing and informing the timing to start user authentication. The authentication data control means A-1 of the computer 1 has the functionality to control, using the timer control means A-7, the start and the end of the automatic update of the random one-time password, which has been described in the second exemplary embodiment. Thus, unauthorized access from a third party other than authorized users can be detected and prevented.

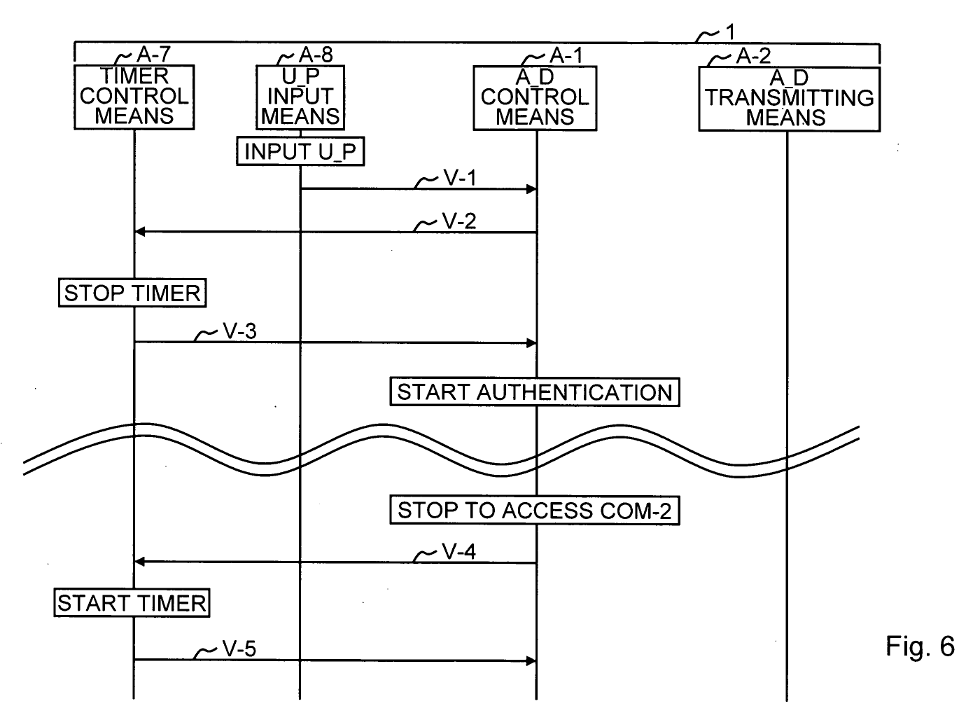

FIG. 6 is a sequence diagram illustrating the operation of the computer 1 according to the present exemplary embodiment. In FIG. 6, U_P stands for user password and R_D stands for random authentication data.

While user authentication request for accessing the computer 2 from the computer 1 has not been started, the automatic update of random one-time password shown in FIG. 5 according to the second exemplary embodiment is periodically carried out.

When a user of the computer 1 inputs his password via the user password input means A-8 (V-1) and starts user authentication requesting process, the authentication data control means A-1 stops an automatic update timer of the timer control means A-7 (V-2 and V-3). Thereafter, the authentication data control means A-1 starts the user authentication requesting process described in the first exemplary embodiment.

From that time, the computer 1 does not carry out the automatic update of a random one-time password described in the second exemplary embodiment until the user authentication has been completed.

When the user authentication has been completed, the authentication data control means A-1 starts the automatic update timer of the timer control means A-7 (V-4 and V-5) and the automatic update of random one-time password described in the second exemplary embodiment is carried out again.

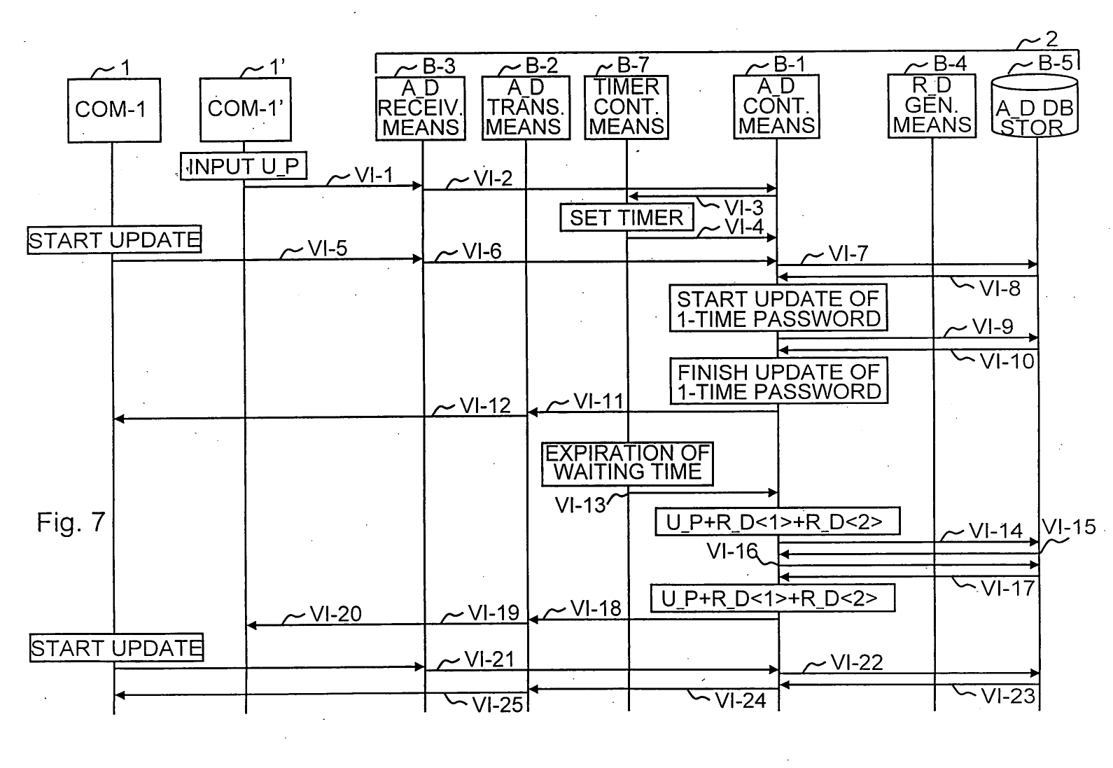

FIG. 7 is a sequence diagram of the user authentication operation performed by the computer 2 according to the present exemplary embodiment. In FIG. 7, U_P stands for user password, and R_D stands for random authentication data.

Here, a computer 1 refers to a computer used by an authorized user after the random one-time password is updated in a normal operation. A computer 1′ refers to a computer used by a third party other than the authorized user in order to carry out user authentication after the third party has acquired the password input by the authorized user and the random one-time password by, for example, wiretapping the communication data between the computer 1 and the computer 2.

A user of the computer 1′ inputs a user password to start user authentication. Authentication data composed of the user password, random authentication data <1>, and random authentication data <2> is transmitted to the authentication data control means B-1 via the authentication data receiving means B-3 of the computer 2 (VI-1 and VI-2). Subsequently, the authentication data control means B-1 requests the timer control means B-7 to set a timer in order to wait for a predetermined time before starting user authentication (VI-3 and VI-4).

In the meantime, automatic update of a random one-time password described in the second exemplary embodiment is periodically carried out between the computer 1 and the computer 2, so that the random authentication data <1> and the random authentication data <2> stored in the computer 1 and the computer 2 are updated to random authentication data <3> and random authentication data <4>, respectively (VI-5 through VI-12).

At that time, the authentication data control means B-1 of the computer 2 references the authentication data database stored in the authentication data database storage B-5 before starting the update of the random one-time password to determine whether user authentication for a computer other than the computer 1 has failed (VI-7). Only when no user authentication has failed (VI-8), the authentication data control means B-1 starts the update of the random one-time password (VI-9).

After waiting for the predetermined time since the computer 2 set the timer (VI-3), the timer control means B-7 transmits a user authentication start message to the authentication data control means B-1 (VI-13).

Here, the waiting time is determined to be longer than the interval of the automatic update of a random one-time password between the computer 1 and the computer 2. Thus, the automatic update of a random one-time password is performed by the computer 1 and the computer 2 at least once during the waiting time. Therefore, when the computer 2 starts the user authentication for the computer 1′, the random one-time password registered in the authentication data database stored in the authentication data database storage B-5 of the computer 2 have already been updated to the random authentication data <3> and the random authentication data <4> by the automatic update requested by the computer 1. Consequently, the user authentication for the computer 1′ fails (VI-14 through VI-19).

Through the above-described operations, unauthorized access from the computer 1′ to the computer 2 can be prevented.

After that, the next automatic update of a random one-time password is requested by the computer 1 to the computer 2.

At that time, the authentication data control means B-1 of the computer 2 references the authentication data database stored in the authentication data database storage B-5 before starting the update of a random one-time password to determine whether user authentication for a computer other than the computer 1 has failed (VI-22).

In this case, since the user authentication for the computer 1′ has failed, the authentication data control means B-1 does not carry out the update of the random one-time password. The authentication data control means B-1 then transmits an update failure message to the computer 1 (VI-24 and VI-25).

In this way, the user of the computer 1 can detect the attempt of unauthorized access to the computer 2.

The computer 2 waits a while before user authentication. The waiting time is set to be longer than the automatic update interval of a random one-time password. Accordingly, even when a third party other than an authorized user acquires a user password and a random one-time password and requests user authentication to the computer 2, an automatic update of a random one-time password for the authorized user is performed before the user authentication, and therefore, the user authentication fails. Thus, the unauthorized access from the third party other than the authorized user can be detected before the user authentication for the third party is completed. On the other hand, the computer 1 stops the automatic update of the random one-time password when requesting user authentication to the computer 2, and resumes the automatic update when the user authentication is completed. That is, the user authentication for the authorized user is performed without being disturbed by the automatic update of the random one-time password. Consequently, the user authentication requested by the computer 1 succeeds.

### Fifth Exemplary Embodiment

According to a fifth exemplary embodiment of the present invention, an authentication system may have a configuration similar to any one of those authentication systems according to the first to fourth exemplary embodiments. In the present embodiment, the computer 1 transmits the computer-1-specific information to the computer 2 in addition to the user password in the user registration phase of the first exemplary embodiment. The computer 2 associates authentication data to be registered in the authentication data database with the computer-1-specific information and, subsequently, manages the authentication data. Accordingly, the computer 1 that is registered in advance can access the computer 2.

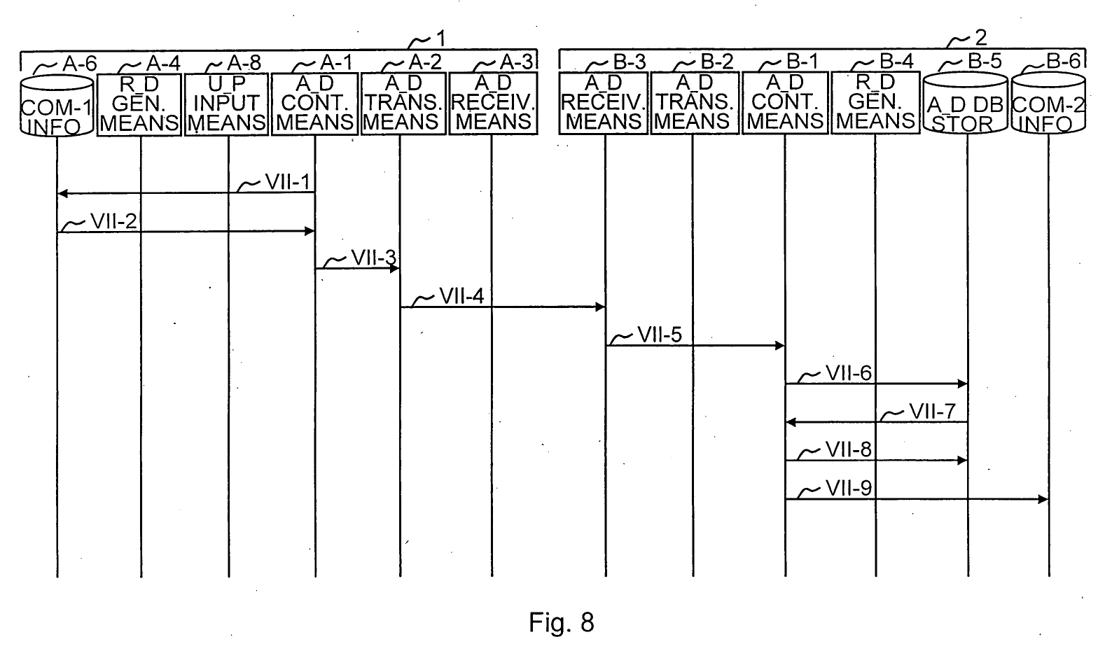

FIG. 8 is a sequence diagram illustrating the operation of the authentication system according to the present exemplary embodiment. In FIG. 8, just the registration process of the computer-1-specific information to be added to FIG. 4 is described.

In the computer 1, in addition to acquiring a user password via user password input means A-8, the authentication data control means A-1 acquires the computer-1-specific information from the computer-1-specific information storage A-6 (VII-1 and VII-2) and transmits data composed of the user password and the computer-1-specific information via the authentication data transmitting means A-2 to the computer 2 (VII-3 and VII-4).

In the computer 2, the authentication data receiving means B-3 receives the data composed of the user password and the computer-1-specific information transmitted from the computer 1 (VII-4) and transmits the data composed of the user password and the computer-1-specific information to the authentication data control means B-1 (VII-5).

The authentication data control means B-1 of the computer 2 performs mutual authentication between the computer 1 and the computer 2 using the user password (VII-6). If the mutual authentication is successful (VII-7), the authentication data control means B-1 registers the computer-1-specific information in the authentication data database stored in the authentication data database storage B-5 (VII-8).

The computer 1 transmits the computer-1-specific information in addition to the user password to the computer 2 when requesting user registration. Thereafter, the computer 2 can perform authentication using the computer-1-specific information instead of authentication using the user password. Consequently, the periodic automatic update of the random one-time password described in the second exemplary embodiment can be performed.

### Sixth Exemplary Embodiment

According to a sixth exemplary embodiment of the present invention, an authentication system has a configuration similar to that of the authentication system according to the first exemplary embodiment. Unlike the first exemplary embodiment, the authentication data control means A-1 of the computer 1 has the functionality to generate a plurality of random one-time passwords using the random-authentication-data generating means A-4 and receives/transmits authentication data from/to the computer 2 via the authentication data receiving means A-3 or the authentication data transmitting means A-2. The authentication data control means B-1 of the computer 2 has the functionality to generate a plurality of random one-time passwords using the random-authentication-data generating means B-4 and receives/transmits authentication data from/to the computer 1 via the authentication data receiving means B-3 or the authentication data transmitting means B-2. Thus, the number of user authentication is increased compared with that in the user authentication process of the first exemplary embodiment.

In step I-5 of FIG. 3, the authentication data control means B-1 of the computer 2 submits a random authentication data generation request.

In step I-6 of FIG. 3, the random-authentication-data generating means B-4 returns random authentication data to the authentication data control means B-1.

In step I-7 of FIG. 3, data composed of a user password and the random authentication data is registered in the authentication data database.

The number of repetitive generations of random authentication data is stored in the computer-2-specific information storage B-6 in advance.

By repeating the sequence from step I-5 through I-7 of FIG. 3, a plurality of data composed of the user password and the random authentication data are registered in the authentication data database stored in the authentication data database storage B-5, and the user password is deleted from a temporal memory of the authentication data control means B-1.

In steps I-9 through I-11 of FIG. 3, the plurality of random authentication data are transmitted from the authentication data control means B-1 of the computer 2 to the authentication data control means A-1 of the computer 1. The authentication data control means A-1 of the computer 1 stores the plurality of random authentication data in a temporal memory thereof.

In step I-12 of FIG. 3, the authentication data control means A-1 of the computer 1 submits a random authentication data generation request.

In step I-13 of FIG. 3, the random-authentication-data generating means A-4 returns random authentication data to the authentication data control means A-1.

In step I-14 of FIG. 3, the authentication data control means A-1 stores data composed of one of the plurality of random authentication data generated by the computer 2 and the random authentication data generated by the computer 1 in the random-authentication-data storage A-5 as a random one-time password.

The number of repetitive generations of random authentication data performed by the computer 1 is stored in the computer-1-specific information storage A-6 in advance.

The sequence of steps I-12 through I-14 is repeatedly carried out.

In the subsequent steps, a matching process is carried out between the computer 1 and the computer 2 using the plurality of random one-time passwords, and the plurality of random one-time passwords are updated. Since these sequences are the same as those of the first exemplary embodiment, descriptions are not repeated.

The authentication system combines a plurality of random authentication data generated by the computer 1 with a plurality of random authentication data generated by the computer 2 so as to generate a plurality of random one-time passwords, which are random authentication data updated each time user authentication is performed. The authentication system stores the plurality of random one-time passwords in storage means of the computer 1 and the computer 2, and performs user authentication using the plurality of random one-time passwords together with the user password.

Since the authentication system generates a plurality of random one-time passwords using the computer 1 and the computer 2 in place of one random one-time password, and performs user authentication using the plurality of random one-time passwords, a reliable and secure user authentication can be achieved.

The number of generations of a random one-time password may be determined and set by the user.

### Seventh Exemplary Embodiment

According to a seventh exemplary embodiment of the present invention, an authentication system may have a configuration similar to any one of those authentication systems according to the first to fourth exemplary embodiments. In the present embodiment, in the computer 2, the authentication data control means B-1 has the functionality to start the update of a random one-time password with the computer 1 using the computer-2-specific information for identifying the computer 2. The timer control means B-7 has the functionality to start the periodic automatic update of a random one-time password. In the computer 1, the authentication data control means A-1 has the functionality to determine whether a random one-time password update request from the computer 2 is valid or not on the basis of information included in the random one-time password update request from the computer 2 and information stored in the random-authentication-data storage A-5. Thus, the computer 1 updates the random one-time password when the automatic update request is transmitted from the computer 2. The operation of the periodic automatic update of a random one-time password is similar to that of the second exemplary embodiment although the operations of the computer 1 and computer 2 are interchanged. Accordingly, description is not repeated.

In the computer 2, the authentication data control means B-1 acquires the computer-2-specific information from the computer-2-specific information storage B-6 and transmits data composed of the computer-2-specific information and the random one-time password via the authentication data transmitting means B-2 to the computer 1.

In the computer 1, the authentication data receiving means A-3 receives the data composed of the computer-2-specific information and the random one-time password transmitted from the computer 2 and delivers the data composed of the computer-2-specific information and the random one-time password to the authentication data control means A-1.

The authentication data control means A-1 of the computer 1 performs mutual authentication between the computer 1 and the computer 2 on the basis of the computer-2-specific information and the random one-time password.

If the mutual authentication between the computer 1 and the computer 2 is successful, the update of the random one-time password starts between the computer 1 and the computer 2.

The computer 2, not the computer 1, requests an automatic update of a random one-time password using the computer-2-specific information instead of the computer-1-specific information. Consequently, the random one-time password is forcibly updated by the server computer.

Furthermore, since the computer 2 requests an automatic update of a random one-time password using the computer-2-specific information, an external computer other than the computer 2 cannot perform an automatic update of a random one-time password in place of the computer 2.

As a result, spoofing by the computer of a third party can be reliably prevented.

### Eighth Exemplary Embodiment

According to an eighth exemplary embodiment of the present invention, an authentication system has a configuration similar to that of the authentication system according to the second exemplary embodiment. Unlike the second exemplary embodiment, the authentication data control means B-1 of the computer 2 has the functionality to manage a user authentication request from the computer 1. Thus, the interval of automatic update of a random one-time password described in the second embodiment can be changed depending on the processing load of the computer 2.

The operation according to the present exemplary embodiment is described below with reference to FIG. 5.

(1) In the operation of the second exemplary embodiment, the timer control means A-7 of the computer 1 sends a random one-time password update request to the authentication data control means A-1 on the basis of the predefined activation interval (IV-1).

(2) The traffic status of the entire system connected to the computer 2 is monitored by, for example, a wireless control system that is out of the scope of the present invention. The monitoring result is sent to the authentication data control means B-1 of the computer 2.

(3) If the authentication data control means B-1 of the computer 2 determines that the traffic of the entire system is congested, the authentication data control means B-1 appropriately determines the interval of the automatic update request of the random one-time password by the computer 1 and transmits the determined interval value to the authentication data control means A-1 of the computer 1.

(4) The authentication data control means A-1 of the computer 1 stores the interval of the automatic update request of the random one-time password in the computer-1-specific information storage A-6. The timer control means A-7 sends a random one-time password update request to the authentication data control means A-1 in accordance with the interval of the automatic update request of the random one-time password stored in the computer-1-specific information storage A-6 (IV-1).

(5) By repeating the operations from (2) to (4), an automatic update request of a random one-time password is carried out on the basis of the variable automatic update interval according to the present exemplary embodiment.

If the authentication data control means B-1 of the computer 2 determines that the traffic congestion of the entire system is mitigated, the authentication data control means B-1 requests the authentication data control means A-1 of the computer 1 to set the interval of the automatic update request back to the predetermined value.

The authentication system can get information on the system traffic of the computer 2 and change the interval of the automatic update request in accordance with the system traffic of the computer 2.

In this way, since the interval of the automatic update request is changed in accordance with the system traffic of the computer 2, the automatic update of a random one-time password is performed at an optimal interval depending on the status of the computer 2. Accordingly, the overload of the computer 2 caused by the automatic update of a random one-time password can be prevented.

As used herein, the term “system traffic” refers to the communication load or the processing load of a computer. The communication load can be determined from the maximum communication speed between the computer 1 and the computer 2. The usage rate of a network (current communication amount/maximum available communication amount) is an example of the communication load. The CPU usage (current processing amount/maximum available processing amount) is an example of the processing load of a computer.

It is desirable that as the load of the computer 2 increases, the interval of the automatic update request of a random one-time password increases. Also, it is desirable that as the number of user authentication requests or the number of unsuccessful authentication for each of user IDs during a predetermined time period increases, the interval of the automatic update request of a random one-time password decreases.

### Ninth Exemplary Embodiment

According to a ninth exemplary embodiment of the present invention, an authentication system may have a configuration similar to any one of those authentication systems according to the first to eighth exemplary embodiments. In the present embodiment, the computer 2 manages a plurality of computer-1-specific information for one user ID, and associates different random one-time password to be registered in the authentication data database with each of the plurality of computer-1-specific information, and manages the different random one-time password. When receiving a user authentication request or an automatic update request of a random one-time password from one of the computers 1, the computer 2 retrieves a random one-time password between the requesting computer 1 and the computer 2 on the basis of the computer-1-specific information from the authentication data database stored in the authentication data database storage B-5. The computer 2 then compares the retrieved random one-time password with the random one-time password included in the authentication data sent from the requesting computer 1. Thus, one user can access the computer 2 using a plurality of physically different computers 1.

FIG. 1 illustrates an exemplary system configuration according to the present invention.

As shown in FIG. 1, one user can access the computer 2 using a plurality of physically different computers 1. Each of the computers 1 includes the random-authentication-data storage A-5 for storing the random one-time password generated by the computer 1 and the computer 2. Also, each of the computers 1 has computer-1-specific information for identifying the computer 1 that is connected to the computer 2.

The computer 2 manages different random one-time passwords, each corresponding to one of the plurality of computers 1 used by the same user.

Random one-time password registered in the authentication data database stored in the authentication data database storage B-5 of the computer 2 is associated with the computer-1-specific information and is managed. By using the method for transmitting the computer-1-specific information from the computer 1 and the method for authenticating the computer-1-specific information performed by the computer 2 described in the fifth embodiment, the plurality of physically different computers 1 used by the same user can be identified.

The computer 2 may require not only the computer-1-specific information described in the fifth embodiment but also information for personal authentication. When authenticating the computer 1, the authentication data control means B-1 compares information for personal authentication sent from the computer 1 with the personal authentication information registered in the authentication data database stored in the authentication data database storage B-5 in order to prevent spoofing. This technique is widely used in existing banking systems. Accordingly, a further description is not provided here. For example, biometrics authentication is employed. In the biometrics authentication, a user is authenticated by using the physical characteristics of the user, such as a fingerprint, a retina, an iris, a voice pattern, or a vein pattern of the palm of the user. That is, by using such biometrics information in the same way as the computer-1-specific information in the authentication, the operation phase shown in FIG. 5 is carried out.

The authentication system treats a plurality of computers 1 for the same user. A random one-time password is used between each of the computers 1 used by the user and the computer 2.

Even when a plurality of the computers 1 request user authentication to the computer 2 using the same user password, for example, even when, as shown in FIG. 1, a computer 1A (a mobile device), a computer 1B (a desktop personal computer), and a computer 1C (a laptop personal computer) request user authentication to the computer 2 using the same user password, different random one-time passwords are used between each of the computers 1 and the computer 2 and the automatic update are performed using the different random one-time passwords between each of the computer 1 and the computer 2. As a result, the user can use a plurality of computers with the same user password.

For example, the computer 2 can identify the user and the computer 1 used by the user on the basis of the computer-1-specific information and the user password.

It will become apparent to those skilled in the art after reading the above disclosure that the features described here can be achieved through the use of a method (a method for user authentication), programs (programs for the computer 1 and the computer 2), and apparatuses (apparatuses executing the programs for the computer 1 and the computer 2).

### EXAMPLES

### Example 1

An example corresponding to the first exemplary embodiment is described next with reference to a banking system that processes deposits to and withdrawals from a saving account. When some user (hereinafter simply referred to as a “user”) accesses a banking system according to the present invention using a mobile device, the user makes user registration first. After the user registration is completed, the user accesses a service (such as a deposit or a withdrawal service) provided by the banking system.

### User Registration

When the user inputs a password “1234” determined by the user (hereinafter referred to as a “user password”) into a mobile device, the user password is transmitted to a server of the banking system (hereinafter simply referred to as a “server”).

Upon receiving the user password “1234”, the server generates random authentication data “abcdefg” (hereinafter referred to as a “server random one-time password”) and transmits the server random one-time password to the mobile device of the user.

Upon receiving the server random one-time password “abcdefg”, the mobile device generates random authentication data “hijklmn” (hereinafter referred to as a “client random one-time password”) and stores the server random one-time password “abcdefg” and the client random one-time password “hijklmn” in a storage area of the mobile device. Subsequently, the mobile device transmits the user password “1234”, the server random one-time password “abcdefg”, and the client random one-time password “hijklmn” to the server.

Upon receiving these three data items, the server registers these three data items in a database of the server.

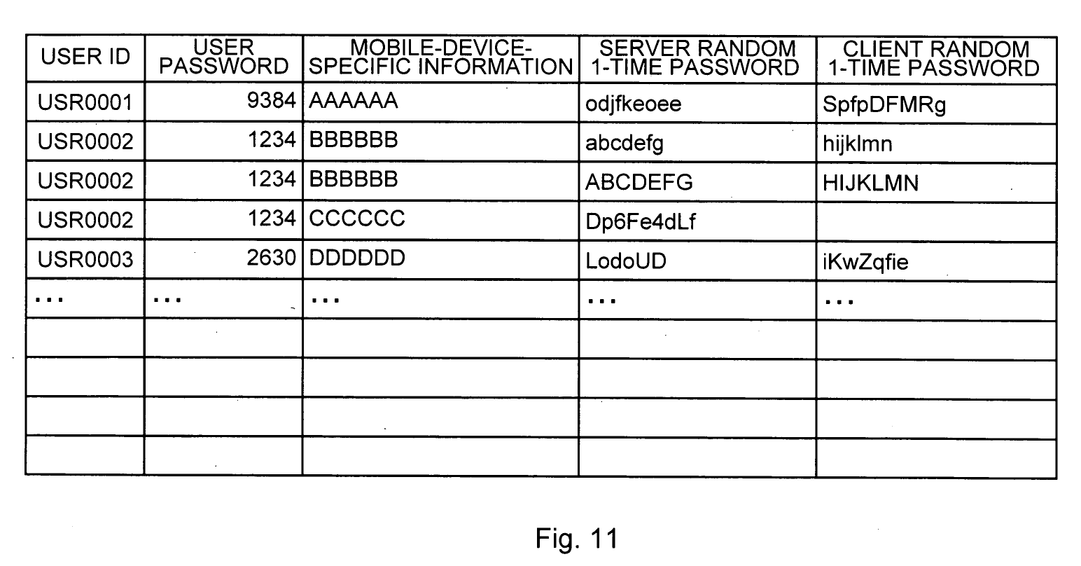

Examples of information registered in the database of the server are shown in FIG. 11.

The user password, the client random one-time password, and the server random one-time password are associated with the user ID and are registered in the database of the server. The database of the server includes random one-time passwords before update and after update as different data.

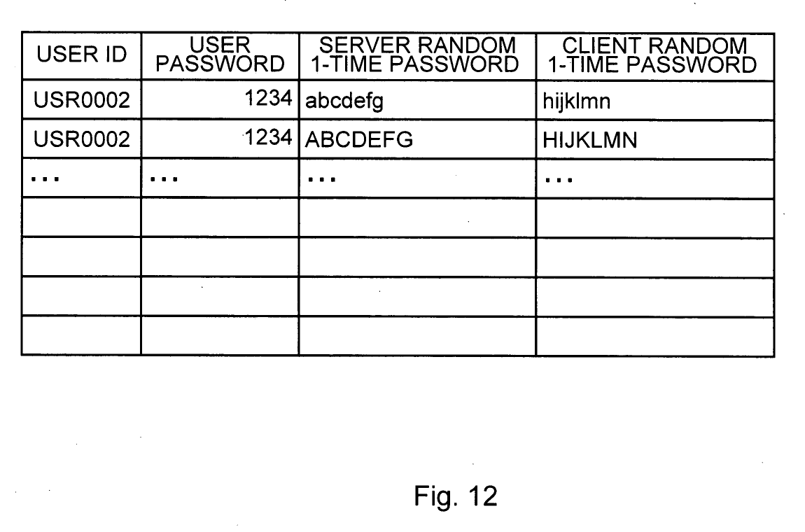

Examples of the information stored in the storage area of the mobile device are shown in FIG. 12.

The client random one-time password and the server random one-time password are associated with the user ID and are stored in the storage area of the mobile device. The storage area of the mobile device stores random one-time passwords before update and after update as different data.

Through the above-described operations, each of the mobile device and the server stores the client random one-time password “hijklmn” and the server random one-time password “abcdefg”. Usage of Service (Deposit or Withdrawal Service) provided by Banking System When the user inputs the user password “1234” that is registered in the server in advance into the mobile device, the mobile device transmits the user password to the server together with the stored client random one-time password “hijklmn” and the server random one-time password “abcdefg”.

Upon receiving these three data items, the server searches the database of the server so as to determine whether the three data items are present or not.

If the three data items are present, the server generates a new server random one-time password “ABCDEFG”, and registers the user password “1234” and the server random one-time password “ABCDEFG” in the database of the server. Subsequently, the server transmits the server random one-time password “ABCDEFG” to the mobile device.

Upon receiving the server random one-time password “ABCDEFG”, the mobile device generates a new client random one-time password “HIJKLMN”, and stores the server random one-time password “ABCDEFG” and the client random one-time password “HIJKLMN” in the storage area of the mobile device. Thereafter, the mobile device transmits the user password “1234”, the server random one-time password “ABCDEFG”, and the client random one-time password “HIJKLMN” to the server.

Upon receiving these three data items, the server searches the database of the server to determine whether the user password “1234” and the server random one-time password “ABCDEFG” are present in the database.

If these two data items are present, the server registers the three data items in the database of the server. The server then transmits an access permission message to the mobile device.

The mobile device deletes the server random one-time password “abcdefg” and the client random one-time password “hijklmn” from the storage area of the mobile device.

After the above-described operations are completed, the mobile device can access the server, and therefore, the processes of deposits to and withdrawals from the banking system become available.

Here, examples of the mobile device used by the user include a cellular phone and a personal digital assistant (PDA) having a function of Internet connection. Examples of communication means between the mobile device and the server include a data communication network provided by a cellular phone carrier and an HTTP protocol-based wireless communication network. However, the mobile device may be replaced by a computer connected to a wired network.

In addition, the transmitted and received data may be encrypted using a known cipher technology.

The function used by the user may be implemented in a computer as the hardware of the computer or as the software running on the computer.

Furthermore, while the example has been described with reference to a banking system, the present invention is applicable to another system that requires user authentication.

### Example 2

An example corresponding to the second exemplary embodiment is described next, in which a mobile device of a user requests a server to update a random one-time password in the server of a banking system at a predetermined interval.

In this case, although the user inputs a user password in Example 1, mobile-device-specific information is used in place of the user password.

Examples of the mobile-device-specific information include subscriber information issued by a cellular phone carrier and a serial number of the mobile device.

Alternatively, the provider of the banking system may provide a unique number to the user. This number is stored in a storage area of the mobile device and is used as the mobile-device-specific information.

The mobile-device-specific information is stored in the storage area of the mobile device and the server in addition to the information described in Example 1.

### Example 3

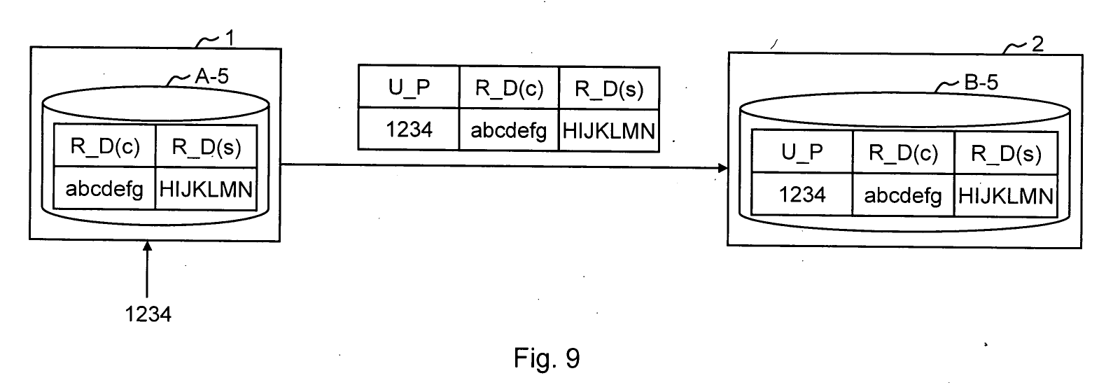

FIG. 9 illustrates Example 3.

Example 3 corresponding to the third exemplary embodiment is described next, in which, when a user password “1234”, a client random one-time password “hijklmn”, and a server random one-time password “abcdefg” are stored in the server of the banking system and a client random one-time password “hijklmn” and a server random one-time password “ABCDEFG” are stored in the storage area of the mobile device, user authentication is performed using the mobile device.

When a user inputs the user password “1234” into the mobile device, the mobile device transmits this user password “1234”, the stored client random one-time password “hijklmn”, and the stored server random one-time password “ABCDEFG” to the server.

Upon receiving these three data items, the server searches the database of the server to determine whether the three data items are present in the database. In this case, the database of the server includes the user password “1234”, the client random one-time password “hijklmn”, and the server random one-time password “abcdefg” for this user. Since the server random one-time password is not correct, the user authentication fails.

Similarly, if the client random one-time password is not correct or the user password is not correct, the user authentication fails.

### Example 4

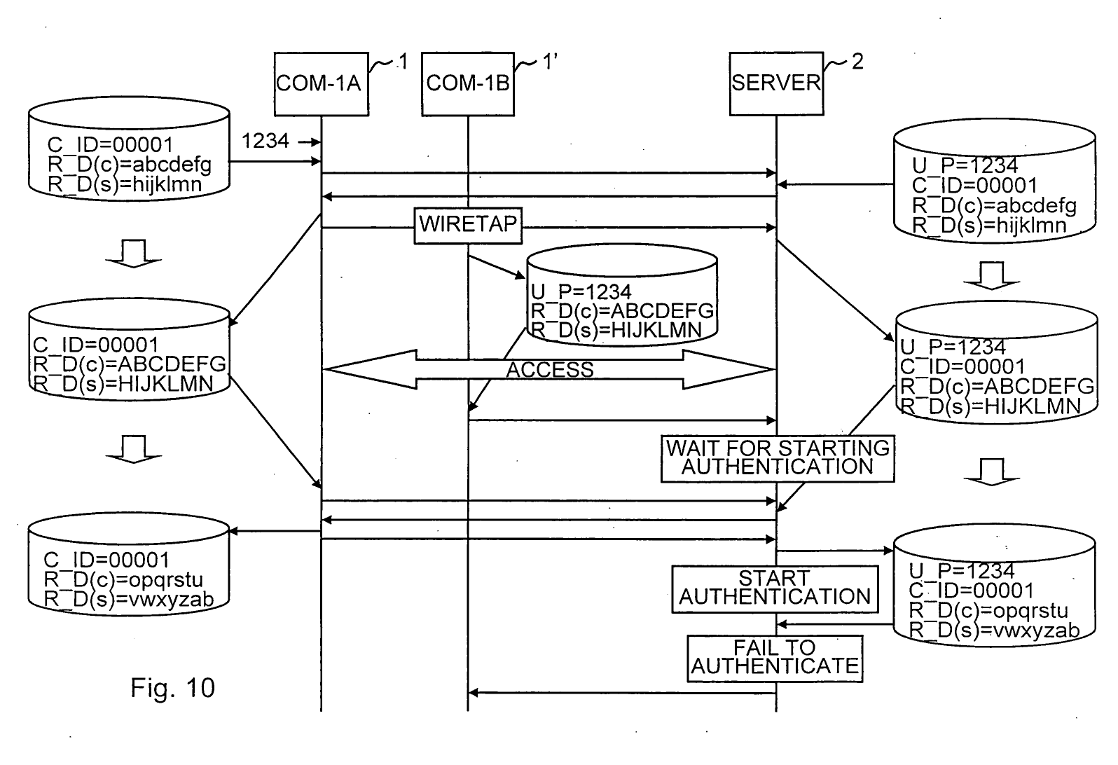

Example 4 corresponding to the fourth exemplary embodiment is described next with reference to FIG. 10. Let a computer 1A be a computer used by an authorized user who has registered in a server of the above-described banking system (hereinafter simply referred to as a “server”). Let a computer 1B be a computer having a user password, a random one-time password, and mobile-device-specific information in the storage area thereof after these data are illegally acquired by, for example, wiretapping. Then, the server performs user authentication for the computer 1B.

For example, suppose that the automatic update of a random one-time password is carried out between the computer 1A and the server every three seconds. Also suppose that after the server receives a user authentication request, the server waits for five seconds to start the user authentication. In this case, even when the computer 1B sends a user authentication request to the server, the computer 1A performs an automatic update of a random one-time password at least once before the server starts the user authentication requested by the computer 1B.

Additionally, while the computer 1A is accessing the server after user authentication is completed, the automatic update request of a random one-time password from the computer 1A stops. To address this issue, the server rejects a user authentication request from another computer during this period. Thus, even when the server receives a user authentication request and an automatic update request of a random one-time password at the same time and the mobile-device-specific information received from two clients are the same, the server can determine that the two requests are sent from different clients.

For example, when the computer 1A requests user authentication to the server, the client random one-time passwords stored in the computer 1A and the server are updated to “ABCDEFG” and the server random one-time passwords stored in the computer 1A and the server are updated to “HIJKLMN”. At that time, a user of the computer 1B acquires these two data items and a user password “1234” by, for example, wiretapping.

When a user of the computer 1A completes the access to the server, the server can accept a user authentication request from the user again.

Here, if the user of the computer 1B requests user authentication to the server using the acquired authentication data, the server waits for five seconds before starting user authentication after the server has received the user authentication request.

Let the interval of automatic update request by the computer 1A be three seconds. Then, the computer 1A having computer-specific information “00001” transmits an automatic update request of the random one-time password to the server before the server starts user authentication.

The server manages the computer-specific information “00001” in association with the authentication information about the corresponding user. As a result of the automatic update, the client random one-time passwords stored in the computer 1A and the server are updated to “opqrstu” and the server random one-time passwords stored in the computer 1A and the server are updated to “vwxyzab”.

Thereafter, the server starts user authentication for the computer 1B. Since the authentication data stored in the server has been updated, the user authentication for the computer 1B fails.

### Example 5

An example corresponding to the fifth exemplary embodiment is described next. In this example, when a user accesses a server of the above-described banking system (hereinafter simply referred to as a “server”) using a mobile device of the user (hereinafter simply referred to as a “mobile device”), the mobile device transmits the mobile-device-specific information to the server in addition to the user password and a random one-time password.

When the mobile device transmits the user password “1234” to the server in Example 1, the mobile-device-specific information “0001” is also transmitted and is registered in the database of the server. Through this operation, when the server authenticates the access from the mobile device, the server may use the mobile-device-specific information instead of or in addition to the user password.

According to Example 5, examples of the mobile-device-specific information include a physical address of the mobile device (such as the MAC global address or the IPv6 address), identification information in an IC card (a user identity module) storing information on a subscriber of the mobile device, identification information in a non-contact Felica® IC card (a universal subscriber identity module), and biometrics authentication information about the user (such as a contactlessly obtained vein pattern of the palm of the user). Thus, one of identification information items that physically identifies the mobile device or the user of the mobile device is used for the mobile-device-specific information. In addition, an Internet security technology, such as the PKI (public key infrastructure) using a digital signature, may be used as a method for mutually authenticating the mobile device and the server. In such a case, a client certificate is recorded in the mobile device whereas a server certificate is recorded in the server.

An exemplary implementation based on a widely used digital signature algorithm using a public key cryptosystem with a hash function and the principle shown in FIG. 2 is described next.

A private key is applied to the computer-1-specific information of the computer 1 to generate a digital signature. The generated digital signature is transmitted to the computer 2. Upon receiving the digital signature, the computer 2 decrypts the digital signature using a public key.

In the computer 1, the authentication data control means A-1 receives the computer-1-specific information and performs a hashing operation on the computer-1-specific information to obtain a message digest (i.e., a digest of the computer-1-specific information). Subsequently, the authentication data control means A-1 generates a digital signature using the obtained message digest.

The computer-1-specific information is encrypted using a private key of the computer 1. The encrypted computer-1-specific information and the generated digital signature are transmitted via the authentication data transmitting means A-2.

In the computer 2, the authentication data receiving means B-3 receives the encrypted computer-1-specific information and the digital signature transmitted from the computer 1 and delivers these data items to the authentication data control means B-1. The authentication data control means B-1 decrypts the encrypted computer-1-specific information and generates a message digest, as in the computer 1. Furthermore, the authentication data control means B-1 decrypts the digital signature using the public key of the computer 1 so as to generate a message digest. By comparing the two message digests, the computer 2 can perform authentication.

If the two message digests are the same, and therefore, the verification of the digital signature is successful, the message digest generated in the authentication data control means B-1 is registered in the authentication data database.

However, if the two message digests are not the same, and therefore, the verification of the digital signature is unsuccessful, authentication using the user password and the random one-time password is not performed.

Since the implementation has been described using some of known technologies, further description is not provided here.

### Example 6

An example corresponding to the sixth exemplary embodiment is described next. In this example, when a user accesses a server of the above-described banking system (hereinafter simply referred to as a “server”) using a mobile device of the user (hereinafter simply referred to as a “mobile device”), a plurality of random authentication data of the mobile device (hereinafter referred to as “client random one-time passwords”) are generated in the mobile device. Also, a plurality of random authentication data of the server (hereinafter referred to as “server random one-time passwords”) are generated in the server.

The server generates a server random one-time password “nmlkjih” in addition to the server random one-time password “hijklmn” described in Example 1. The mobile device generates a client random one-time password “gfedcba” in addition to the client random one-time password “abcdefg”. These random one-time passwords are held by the mobile device and the server and are used for authentication.

Through the above-described operation, if a third party attempts unauthorized access using wiretapping, the third party needs to wiretap the plurality of server random one-time passwords and the plurality of client random one-time passwords.

Here, the description is made using only two server random one-time passwords and only two client random one-time passwords. However, three or more server random one-time passwords and three or more client random one-time passwords can be used.

### Example 7

An example corresponding to the seventh exemplary embodiment is described next. In this example, a server of the above-described banking system (hereinafter simply referred to as a “server”) requests an automatic update of a random one-time password to a mobile device of the user (hereinafter simply referred to as a “mobile device”).

In Example 2, the mobile device sends an automatic update request of a random one-time password using the mobile-device-specific information. Instead, the server sends an automatic update request of a random one-time password using server-specific information.

One of the examples of the server-specific information is a digital certificate provided by a certifying authority. The storage area of the mobile device and the server store the server-specific information in addition to the information described in Example 1.

Also, examples of the server-specific information include identification information for physically identifying the server or the user of the server. Since this has been described in Example 5, the description is not repeated.

Furthermore, examples of the server-specific information include a server certificate according to the Internet security technology using the PKI (public key infrastructure) based on a digital signature, which is described in Example 5. Thus, the server certificate of the server and the mobile-device-specific information are stored, and therefore, the server can send an automatic update request of a random one-time password to the mobile device.

The existing technology (such as Internet security technology) used in this example will be understood by those of skill in the art, and therefore, a further description is not provided herein.

### Example 8

An example corresponding to the eighth exemplary embodiment is described next. In the currently available cellular phone services, congestion that disables telephone conversations and e-mail communications could occur when a disaster (such as earthquake, typhoon, or a significant emergency) strikes. This is because the devices or networks of wireless control systems are overloaded due to an excessive number of telephone calls and e-mails requesting for information about the current status of the situation at the disaster site. Additionally, cellular phone carriers restrict the number of calls and the number of location registration messages. In the case of congestion, the periodic automatic update operation described in Example 2 may be stopped or the priority of the periodic automatic update operation may be decreased. The computer 2 acquires the monitoring result of traffic status of the entire system and can change the automatic update interval of a random one-time password in accordance with the status.

### Example 9

As described in the ninth exemplary embodiment, a variety of usages can be provided. To further enhance the security of the registered mobile devices and computers, the computer 2 may require not only the computer-1-specific information described in the fifth exemplary embodiment but also personal authentication for the banking system. The user authentication for a first access from the computer 1 is performed by verifying a variety of information, such as a personal identification number, a password, and a combination of a question and an answer that only a user knows, so that spoofing is reliably prevented. Since this is performed in widely used banking systems, further description is not provided herein. After authentication using the computer-1-specific information and authentication information related to the banking system is successfully performed, the computer 2 manages different one-time passwords, each corresponding to one of a plurality of the computers 1 having the same user ID stored in the authentication data database.

While the present invention has been described with reference to exemplary embodiments and examples, it is to be understood that the invention is not limited to the disclosed exemplary embodiments and examples. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An authentication system comprising a first apparatus and a second apparatus connected each other via a network,
said first apparatus comprising:
an input means for inputting a user password used for user authentication,
a first receiving means for receiving second random authentication data from the second apparatus,
a first authentication data generating means for generating first random authentication data,
a first storage for storing a random one-time password, said random one-time password including the second random authentication data received from the second apparatus and the first random authentication data, and
a first transmitting means for transmitting the user password and the random one-time password to the second apparatus, and for transmitting a user authentication request including the user password and the random one-time password to the second apparatus, and
said second apparatus comprising:
a second receiving means for receiving the user password and the random one-time password from the first apparatus, and for receiving the user authentication request from the first apparatus,
a second authentication data generating means for generating the second random authentication data,
a second storage for storing the user password, and for storing the random one-time password received from the first apparatus with the user password,
a second transmitting means for transmitting the second random authentication data to the first apparatus, and
a second authenticating means for authenticating a sender of the user authentication request by matching the user password and the random one-time password included in the user authentication request with the user password and the random one-time password stored in the second storage respectively.

2. The authentication system of claim 1, wherein
the first storage further stores first specific data for identifying the first apparatus;
the first transmitting means further transmits the user password and the first specific data to the second apparatus;
the first transmitting means further transmits an automatic update request to the second apparatus at a first predetermined interval, said automatic update request including the first specific data and the random one-time password;
the second receiving means further receives the user password and the first specific data from the first apparatus;
the second storage further stores the first specific data with the user password;
the second receiving means further receives the automatic update request from the first apparatus; and
the second authenticating means further authenticates a sender of the automatic update request by matching the first specific data and the random one-time password included in the automatic update request with the first specific data and the random one-time password stored in the second storage respectively.

3. The authentication system of claim 2, wherein
the first transmitting means stops transmitting the automatic update request before transmitting the user authentication request and resumes transmitting the automatic update request after the completion of the user authentication; and
the second authenticating means waits for a third predetermined interval before starting the user authentication, said third predetermined interval being longer than the first predetermined interval.

4. The authentication system of claim 2, wherein
the second apparatus further comprising an update interval determining means for determining an interval of transmitting the automatic update request by the first transmitting means;
the second transmitting means further transmits data of the interval determined by the update interval determining means to the first apparatus;
the first receiving means further receives from the second apparatus the data of the interval determined by the update interval determining means; and
the first transmitting means transmits the automatic update request at the interval determined by the update interval determining means instead of the first predetermined interval.

5. The authentication system of claim 1, wherein
the second storage further stores second specific data for identifying the second apparatus;
the second transmitting means further transmits the second specific data to the first apparatus;
the second transmitting means further transmits an automatic update request at a second predetermined interval, said automatic update request including the second specific data and the random one-time password to the first apparatus;
the first receiving means further receives the second specific data from the second apparatus;
the first storage stores the second specific data with the random one-time password;
the first receiving means further receives the automatic update request from the second apparatus; and
the first apparatus further comprising a first authenticating means for authenticating a sender of the automatic update request by matching the second specific data and the random one-time password included in the automatic update request with the second specific data and the random one-time password stored in the first storage respectively.

6. A first apparatus connectable to a second apparatus via a network, comprising:
an input means for inputting a user password used for user authentication;
a first receiving means for receiving second random authentication data from the second apparatus;
a first authentication data generating means for generating first random authentication data;
a first storage for storing a random one-time password; said random one-time password including the second random authentication data received from the second apparatus and the first random authentication data; and
a first transmitting means for transmitting the user password and the random one-time password to the second apparatus, and for transmitting a user authentication request including the user password and the random one-time password to the second apparatus.

7. The first apparatus of claim 6, wherein
the first storage further stores first specific data for identifying the first apparatus;
the first transmitting means further transmits the user password and the first specific data to the second apparatus; and
the first transmitting means further transmits an automatic update request to the second apparatus at a first predetermined interval, said automatic update request including the first specific data and the random one-time password.

8. The first apparatus of claim 7, wherein
the first transmitting means stops transmitting the automatic update request before transmitting the user authentication request and resumes transmitting the automatic update request after the completion of the user authentication.

9. The first apparatus of claim 7, wherein
the first receiving means further receives from the second apparatus the data of an interval determined by the second apparatus; and
the first transmitting means transmits the automatic update request at the interval received from the second apparatus instead of the first predetermined interval.

10. The first apparatus of claim 6, wherein
the first receiving means further receives from the second apparatus second specific data for identifying the second apparatus;
the first storage stores the second specific data with the random one-time password;
the first receiving means further receives from the second apparatus an automatic update request including the second specific data and the random one-time password; and
the first apparatus further comprising a first authenticating means for authenticating a sender of the automatic update request by matching the second specific data and the random one-time password included in the automatic update request with the second specific data and the random one-time password stored in the first storage respectively.

11. A second apparatus connectable to a first apparatus via a network, comprising:
a second authentication data generating means for generating second random authentication data;
a second transmitting means for transmitting the second random authentication data to the first apparatus;
a second receiving means for receiving a user password and a random one-time password from the first apparatus, said random one-time password including first random authentication data generated in the first apparatus and the second random authentication data, and for receiving a user authentication request including the user password and the random one-time password from the first apparatus;
a second storage for storing the user password, and for storing the random one-time password received from the first apparatus with the user password; and
a second authenticating means for authenticating a sender of the user authentication request by matching the user password and the random one-time password included in the user authentication request with the user password and the random one-time password stored in the second storage respectively.

12. The second apparatus of claim 11, wherein
the second receiving means further receives from the first apparatus the user password and first specific data for identifying the first apparatus;
the second storage further stores the first specific data with the user password;
the second receiving means further receives an automatic update request from the first apparatus, said automatic update request including the first specific data and the random one-time password; and
the second authenticating means further authenticates a sender of the automatic update request by matching the first specific data and the random one-time password included in the automatic update request with the first specific data and the random one-time password stored in the second storage respectively.

13. The second apparatus of claim 12, wherein
the second authenticating means waits for a third predetermined interval before starting the user authentication, said third predetermined interval being longer than the first predetermined interval.

14. The second apparatus of claim 12, wherein
the second apparatus further comprising an update interval determining means for determining an interval of transmitting the automatic update request by the first transmitting means; and
the second transmitting means further transmits data of the interval determined by the update interval determining means to the first apparatus.

15. The second apparatus of claim 11, wherein
the second storage further stores second specific data for identifying the second apparatus;
the second transmitting means further transmits the second specific data to the first apparatus;
the second transmitting means further transmits an automatic update request at a second predetermined interval, said automatic update request including the second specific data and the random one-time password to the first apparatus;

16. An authentication method carried out by a second apparatus with a first apparatus connected to the second apparatus via a network, said second apparatus including a second storage storing a user password, said authentication method comprising:
a second authentication data generating step of generating second random authentication data;
a second transmitting step of transmitting the second random authentication data to the first apparatus;
a second receiving step of receiving a user password and a random one-time password from the first apparatus, said random one-time password including first random authentication data generated in the first apparatus and the second random authentication data; and
a second storing step of storing the random one-time password with the user password;
a second request receiving step of receiving a user authentication request including the user password and the random one-time password;
a second user authenticating step of authenticating a sender of the user authentication request, by matching the user password and the random one-time password included in the user authentication request with the user password and the random one-time password stored in the second storage respectively.

17. The authentication method of claim 16, said authentication method further comprising:
a second specific data receiving step of receiving from the first apparatus the user password and first specific data for identifying the first apparatus;
a second specific data storing step of storing the first specific data with the user password into the second storage;
a second update request receiving step of receiving an automatic update request from the first apparatus, said automatic update request including the first specific data and the random one-time password; and
a second updater authenticating step of authenticating a sender of the automatic update request, by matching the first specific data and the random one-time password included in the automatic update request with the first specific data and the random one-time password stored in the second storage respectively.

18. The authentication method of claim 17, wherein
in the second user authenticating step, the user authentication is put off for a third predetermined interval, said third predetermined interval being longer than the first predetermined interval.

19. The authentication method of claim 17, further comprising:
an update interval determining step of determining an interval of transmitting the automatic update request by the first apparatus; and
an interval transmitting step of transmitting data of the interval determined in the update interval determining step to the first apparatus.

20. The authentication method of claim 16, said second storage further storing second specific data for identifying the second apparatus, said authentication method further comprising
a second specific data transmitting step of transmitting the second specific data to the first apparatus;
a second update request transmitting step of transmitting an automatic update request to the first apparatus at a second predetermined interval, said automatic update request including the second specific data and the random one-time password.
